(19) United States
(12) Patent Application Publication
(10) Pub. No.: US 2011/0220253 A1
(43) Pub. Date: Sep. 15, 2011

(54) TYING MACHINE

(75) Inventors: Bernard Cullen, Renfrewshire (GB); Kenneth Sorley, Renfrewshire (GB); James John Pirrett Higgins, Glasgow (GB); Charles Thomas Marshall, Renfrewshire (GB); David Michael Stalker, Renfrewshire (GB)

(73) Assignee: BAE SYSTEMS PLC, London (GB)

(21) Appl. No.: 13/130,421

(22) PCT Filed: Nov. 25, 2009
(86) PCT No.: PCT/GB09/51594

§ 371 Date: May 20, 2011

(30) Foreign Application Priority Data
Nov. 25, 2008 (EP) 08253806.7
Nov. 25, 2008 (GB) 0821534.5

(51) Int. Cl. C06B 45/12; B30B 9/30; B65B 13/02

(52) U.S. Cl. 149/14; 100/8; 100/2

(57) ABSTRACT

There is disclosed a tying machine (100) for forming bundles from a plurality of propellant sticks (4). Such bun-files may be used to form a propellant charge for use in, for example, heavy artillery. The tying machine tends to comprise an aperture (6) and a work surface (8) such that the plurality of sticks may rest on the work surface and occupy a portion of the aperture. Further, a drum (10) holding one end of a length of twine surrounds the aperture and can be rotated to wind the twine around the sticks. The twine can be secured once the sticks are bound.

The following invention relates to a tying machine suitable for binding a plurality of propellant sticks to form a bundle, the bundle being suitable for use as a propellant charge. The invention also relates to a propellant charge such as may be formed by such a machine, and in particular where the binding is effected by a resilient ligature.

Gun propellant material is generally supplied in one of two forms: granular or stick.

When supplied in granular form, the final gun propellant charge is assembled by filling cloth bags with the granules of propellant material.

When the propellant material is in stick form, the propellant charge is assembled from a bundle of sticks or alternatively from several bundles of sticks. Each bundle contains a plurality of sticks of propellant of a fixed diameter. Where the propellant charge is composed of several bundles of sticks, the fixed stick diameter may vary between bundles.

To aid in assembly of the final gun propellant charge, and to maintain the gun propellant charge in shape during use, each bundle of sticks is bound together using a generally inextensible ligature. When several bundles are combined, these bundles may also be tied together with a generally inextensible ligature to form one assembled gun propellant charge.

Thus, a range of different propellant charges can be produced by assembling varying weights of fixed diameter propellant sticks and binding the sticks together into the desired bundles.

Typically, the sticks are arranged into the desired form by a human operator who subsequently lashes the sticks together into a preliminary bundle. This preliminary bundle is then tied using a plurality of manually applied generally inextensible ligatures to form the bundle. To fix the knot in place and prevent it from untying, a small quantity of lacquer or varnish is placed on the knot. The bundle is then inserted into a cloth bag or propelling charge container.

Thus is known a method of producing a propellant charge.

However, manually tying the sticks together is repetitive and strenuous to the extent that over the course of their employment, and despite due care being taken, a human operator could develop an injury such as Repetitive Strain Injury. In addition, the operator could regularly receive cuts or abrasions on their hands.

Further, the quality of the bundle can vary with the operator's moment to moment condition. For example, if an operator ties bundles together all day long, the bundles tied at the end of the day may tend to be looser than those tied at the beginning of the day because the operator will have tired.

It is therefore an object of the invention to provide a machine for tying a plurality of propellant sticks together such that at least one of the disadvantages of the above mentioned art may be mitigated.

Accordingly there is provided a tying machine suitable for binding a plurality of propellant sticks to form a bundle, the bundle being suitable for forming a propellant charge, wherein the machine is adapted for use with sensitive combustible materials.

Advantageously, such a machine can provide propellant bundles but does not tend to expose operators to the hazards present in the prior art such as repetitive strain injury to the upper body or cuts and abrasions to the hands. Further, the machine is adapted to mitigate any raised risk of igniting the propellant sticks (as might be associated with automation) and thus manages to conform to safety requirements.

Still further, compared to manual tying, the automation of the bundling process can free up the human operator and so the human operator may attend to other tasks and thus reduce the overall time taken to produce a charge.

Preferably, the tying machine comprises a housing defining an aperture such that the aperture may accommodate the plurality of propellant sticks; a shuttle for engaging a portion of a ligature; a holder fixed to the housing, the holder being suitable for holding a reservoir of ligature, the reservoir being suitable for evolving the ligature, wherein, if the shuttle engages a portion of the ligature, and if the plurality of propellant sticks are suitably disposed in the aperture, the shuttle can be moved relative to the plurality of propellant sticks to wind the ligature around the plurality of propellant sticks to form the bundle.

Further, the tying machine may be provided with a rotatable drum surrounding the aperture, to which the shuttle is fixed, such that rotating the drum tends to wind the ligature around the plurality of suitably disposed propellant sticks to form the bundle.

Beneficially, such a machine performs the tying operation and so, at most, requires the human operator to support the sticks for the duration of the process. Thus there is no need for a preliminary tie and, in thus eliminating a step in the manufacturing process, tends to make the process quicker and simpler in comparison to the known manual process.

Further, where the plurality of sticks can remain generally static for the tying operation, such a machine is able to consistently tie the sticks together in bundles so as to be able to form tightly bound propellant charges.

A benefit of having tightly bound bundles is that the bundles will be easier to insert into their cloth bags or charge containers as the tightly bound bundles will tend to keep their shape.

The tying machine may further comprise a work surface upon which the plurality of propellant sticks may rest. Having such a work surface allows the sticks to be generally unattended by human operators.

Also, because a work surface can tend to hold the sticks in a more stable condition than a human operator, the consistency of the bundle can tend to improve further.

Consistency from bundle to bundle is beneficial because it helps to maintain regular ballistics. If each bundle of propellant sticks is formed by the same method, it will have the same characteristics. Such characteristics include the rate at which the propellant develops gas products (which can vary with the surface area of the propellant material exposed). The muzzle velocity of the projectile is dependent on this rate and thus the consistency of the bundle can enable the gun to fire consistently.

The firing consistency can, in part, be attributed to the regular ignition path conferred by the consistent arrangement of the sticks.

A consistent bundle also lowers the risk of known hazards, associated with propellant charges, such as ‘hang fire’ when the propellant is still combusting once the breech is reopened after firing.

The tying machine can also comprise a drive for rotating the drum, the drive conforming to explosive electrical standards.

The inventors have identified electrical components as being a source of risk in using a machine to bind propellant charges. This may generally prejudice skilled men against using electrical components in the processing of highly sensitive materials such as gun propellants; however, the inventors have appreciated that electrical components can be made in such a way as to render them safe for use with highly sensitive materials such as gun propellants—for example, by designing to reduce the risk of electrical sparking.

The tying machine may also comprise a feed mechanism for pulling the ligature out from the reservoir evenly as the shuttle moves. Further, the feed mechanism may comprise a tensioning means, for conducting the ligature between the holder and the shuttle, such that the portion of the ligature extending from the tensioning means to the shuttle is at a generally constant tension. Preferably the feed mechanism and the tensioning means are suitable for conducting a resilient ligature.

If the ligature is pulled out and applied evenly then the sticks will tend to be bound evenly and thus both the feed mechanism and the tension spring further assure the consistency of the bind and so further confer the related benefits.

The tying machine may further comprise a knotting mechanism for, once the plurality of propellant sticks are surrounded by the ligature, fixing the end of the ligature to another section of the ligature. The knotting mechanism can comprise an electrical drive conforming to explosive electrical standards.

According to a second aspect of the invention there is provided a process of forming a propellant charge using a tying machine comprising a housing defining an aperture such that the aperture may accommodate the plurality of propellant sticks; a rotatable drum surrounding the aperture; and a shuttle, fixed to the drum, for engaging a portion of a ligature; a holder fixed to the housing, the holder being suitable for holding a reservoir of ligature, the reservoir being suitable for evolving the ligature, the process comprising the steps of:
i) arranging a plurality of sticks of propellant material into a bundle form,
ii) placing the plurality of sticks within the aperture,
iii) rotating the shuttle about the plurality of sticks for at least one complete revolution, the shuttle being fixed to a portion of a ligature so that the ligature is wound around the bundle form, and
iv) securing the ligature to bind the sticks.

Additionally, the process may comprise any combination of the further steps of:
a) selecting how many revolutions are to be completed prior to securing the ligature, and
b) selecting how many ligatures are to secure the plurality of sticks, and if more than one ligature is selected, moving the plurality of sticks from one circumference to another circumference after securing the ligature and repeating steps iii) and iv) accordingly.

Such a method tends to be safer and quicker than previously employed methods and can produce a better quality product.

According to a third aspect of the invention, there is provided a propellant charge comprising: a plurality of sticks formed from propellant material, the sticks being arranged in a bundle form; a resilient ligature surrounding the bundle at least one circumference, wherein the resilient ligature is secured such that it holds the sticks of propellant material in the bundle form.

Regardless of whether the bundle is created by a machine or by hand, it is advantageous to form a bundle with resilient ligature as opposed to the generally inextensible ligature previously employed. This is because the resilient ligature can more easily be applied so as to bind the sticks. Further, the resilient ligature can tend to grip the bundle better than an inextensible ligature, particularly if the resilient ligature is secured in a stretched condition.

A resilient ligature also helps to increase the strength of the bundle, relative to a bundle tied with a generally inextensible ligature. The strength can be attributed to the way that the tight binding will reduce the possibility of an individual shaft from being misaligned with the longitudinal axis of the bundle. A misaligned shaft would be prone to experiencing bending moments and having shear stresses induced in it when a longitudinal force is applied to the bundle (e.g. when being rammed).

The resilient ligature enables the bundle to be tightly bound but also allows the bundle to have a degree of flexibility with which to withstand forces such as might be experienced as the bundle vibrates. The resilient ligature tends to act as a damper for the whole bundle, dampening out vibrations.

Further, the resilient ligature will reduce the possibility of vibration of individual sticks because the consistent and tight bind will tend to remove the space in which such vibration could occur.

Still further, the resilient ligature can be stretched during the securing stage of the manufacture so that it may be held away from the plurality of securing sticks and thereby is readily accessible to better facilitate the securing. Beneficially, once knotted in this extended state, and subsequently released from the knotting mechanism, the ligature will tend to contract to grip the bundle. This effectively does away with the need for lacquer or varnish to aid with the securing process and so makes the manufacture quicker in comparison to the manual technique using generally inextensible cord.

Preferably the ligature has a resilience such that it can extend to between 120% and 250% of its original, unstretched, length without exceeding the elastic limit. As such, the ligature can remain resilient as it is stretched to a length of between 120% and 250% of its original, unstretched, length. This is considered by the applicant to be a beneficial resilience range for this invention.

The ligature may be such that beyond a certain extension, generally inextensible components in the ligature may bear the tensile load. Such inextensible components may be provided on the unstretched ligature in a slackened state (e.g. a concertina-shaped sheath) to allow the ligature to extend until the slack is taken up. As such, the resilient components of the ligature can be prevented from extending beyond their elastic limit.

The resilient ligature may be composed of resilient polymeric material and in particular may be composed of a combination of polyamide, polyester and rubber. Alternatively, the resilient ligature may be composed of a combination of cotton, polyester and rubber.

A ligature thus composed not only achieves a suitable elasticity but also has been shown, when fired, to combust in the barrel of a gun without leaving debris that might require the breech to be cleaned between firings.

The resilient ligature may be secured by way of a knot and where a knot secures the bundle, the tension in the ligature tends advantageously to tighten the knot, removing the need for lacquer or varnish to be applied and so making manufacture quicker.

The resilient ligature may comprise a protective sheath surrounding at least one resilient cord. The protective sheath may comprise cotton or consist of cotton. The resilient cord may comprise a combination of polyester and rubber. The at least one resilient cord may comprise a plurality of intertwined resilient cords.

The provision of a protective sheath around the resilient cord tends to give the ligature, an improved resistance to chemical reactions. Such reactions could lead to degradation in the ligature's ability to bind the sticks.

So that the invention may be more fully appreciated embodiments will be discussed in the following description and with reference to the figures of which:

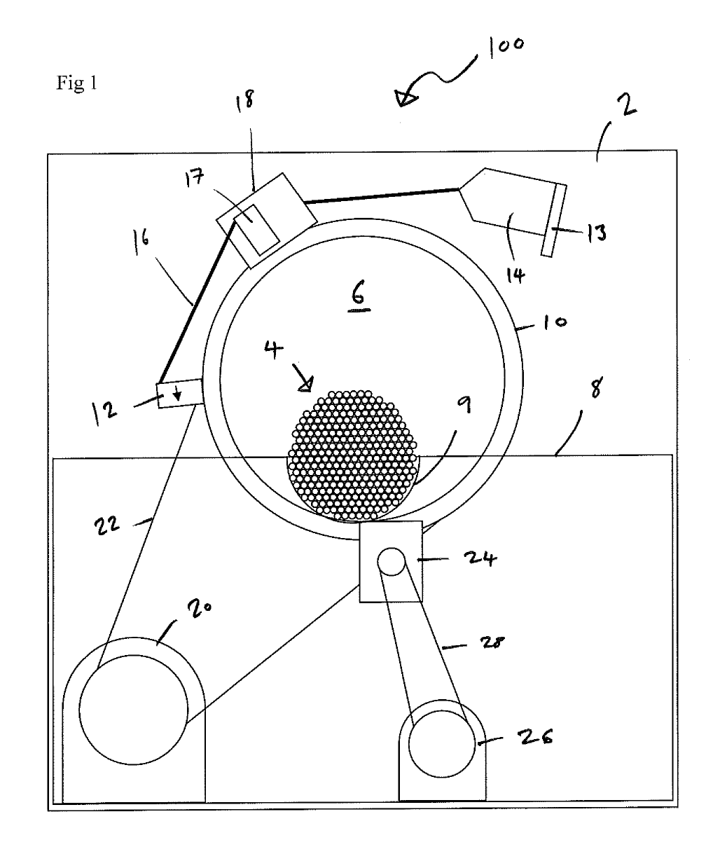

FIG. 1 shows a tying machine according to the invention with a plurality of propellant sticks disposed in it;

FIG. 2 shows a second embodiment of a tying machine according to the invention at a first stage in a tying operation;

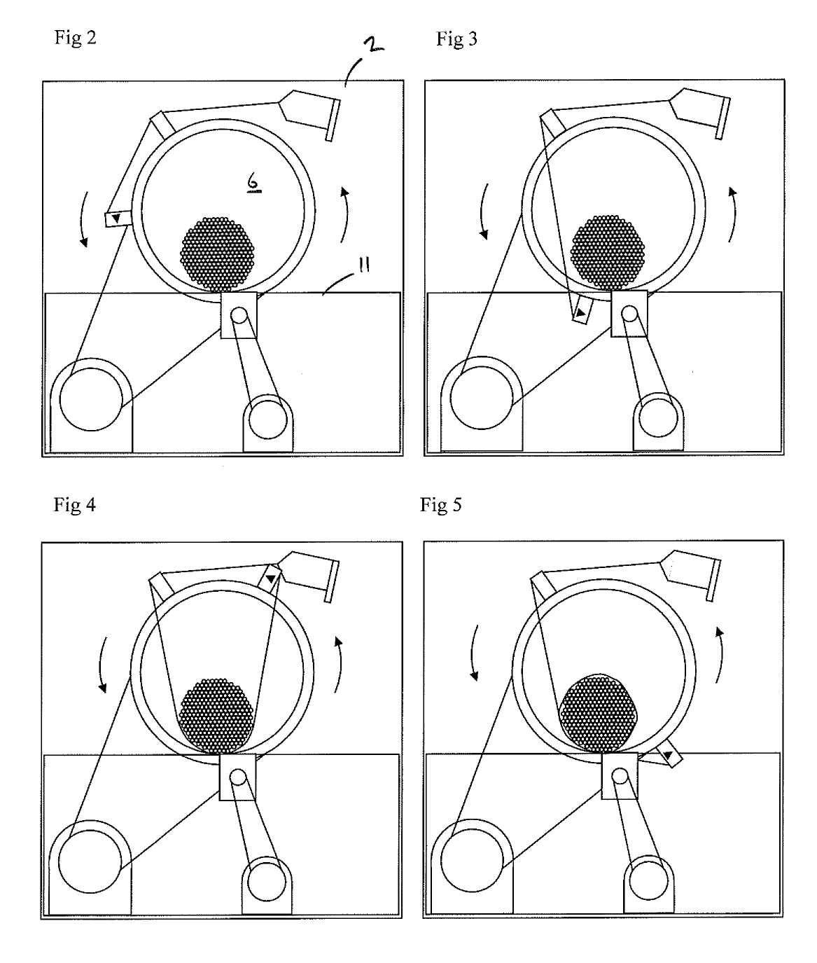

FIG. 3 shows the tying machine of FIG. 2 at a second stage of a tying operation;

FIG. 4 shows the tying machine of FIG. 2 in a third stage of a tying operation; and

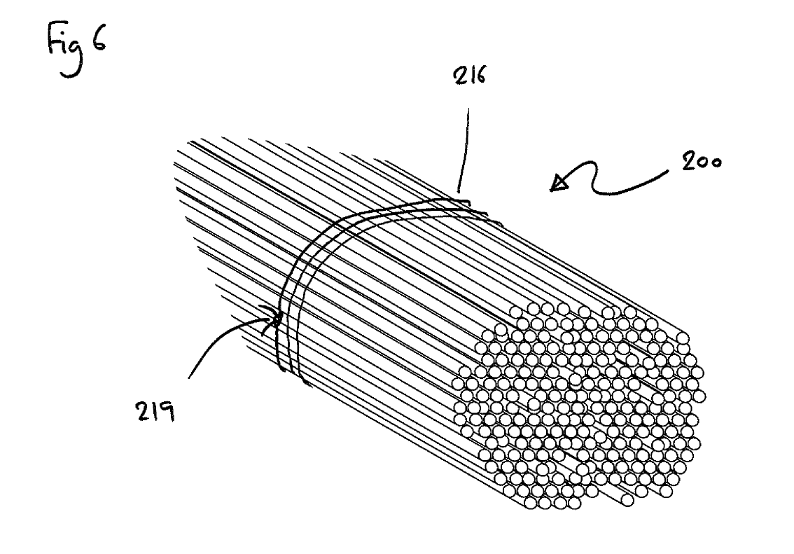

FIG. 5 shows the tying machine of FIG. 2 at a third and final stage of a tying operation.

FIG. 6 shows a three-dimensional representation of a bundle.

A tying machine 100, as can be seen in FIG. 1, is provided with a housing 2 that generally contains the other components of the tying machine 100. The housing 2 has an aperture 6 into which a plurality of sticks 4 may be placed and is also provided with a work surface 8 upon which the plurality of sticks 4 may rest. A portion of the work surface 8 is offset from the aperture whilst another portion extends into the aperture 6 such that the plurality of sticks 4 may simultaneously occupy the aperture 6 and rest on the work surface 8. The work surface 8 comprises a bundle-shaped recess 9.

The recess 9 has a trough shape and thereby defines a curved surface for channelling the sticks into the appropriate bundle form. In the current embodiment, the recess 9 is shaped to fit a portion of a circular cylinder with an appropriate diameter of approximately 155 mm such that the bundles may be used for 155 mm caliber rounds of ammunition.

In the embodiment of the tying machine shown in FIGS. 2 to 5, the work surface 11 is a generally flat surface which extends to the aperture. Thus sticks being bound by this particular tying machine are supported partially by the flat surface of the work surface 11 and partially be the walls of the housing 2 that define the aperture 6.

In the embodiments of FIGS. 1 and 2, the aperture 6 is surrounded by a drum 10 that is mounted on bearings (not shown) such that the drum may rotate about the aperture. The bearings and drum 10 are arranged so that a limitless number of revolutions may be completed. A shuttle 12 is fixed to the drum 10. The shuttle 12 has a clamp (not shown) for engaging a portion of a ligature 16.

Attached to the housing 2 is a holder 13 which is suitable for having a ligature reservoir 14 attached to it. A ligature 16 extends from the ligature reservoir 14 and is conveyed to the shuttle 12 via a feed mechanism 18 comprising a tensioning spring 17. The tensioning spring 17 is adapted to enable the paying out of resilient ligature at a generally constant tension.

Ligature 16 comprises a generally inert sheath (not shown) surrounding a plurality of wound elastic cords. The ligature 16 is generally resistant to reaction with the propellant sticks.

Further, the sheath of the ligature 16 is formed from a generally inextensible material but which is in a bunched or otherwise slackened condition when the ligature 16 is in an unstretched state. Thus, as the ligature is initially stretched and until the slack in the sheath is taken up, the wound elastic cords provide the ligature 16 with a resilience. When the slack in the sheath is taken up, the ligature 16 becomes generally inextensible.

One preferred ligature 16 is supplied under the name ‘TOM4-Twist F402’ (TOM4) and is manufactured and distributed by TOM Tye-O-Matic BV of Postbus 146 7150AC, Eibergen, Netherlands (website: www.tye-o-matic.nl, e-mail: tom@tye-o-matic.nl). The applicant has found that TOM4 is generally resistant to chemical reaction when kept in contact with a nitro-glycerine, nitrocellulose and nitro-guanidine based propellant at 65° C. for approximately 8 weeks. Thus the ligature is sufficiently resistant to comply with the relevant NATO standardisation agreement. Other ligatures may tend to react with their environment, and thus degrade, in such situations and so are not necessarily compliant. TOM4 comprises a cotton sheath which surrounds a plurality of wound resilient cords. By weight, TOM4 is composed of 20% cotton, 65% polyester white and 20% food grade rubber. TOM4 has an elasticity (as a percentage) in the region of 150% and a UTS of 18-22 kg.

As an alternative to TOM4, the ligature 16 may be ‘CES Elasticated Food Twine’ which is composed of 65% polyamide, 15% polyester and 20% rubber by weight. Such a ligature can be obtained from Cutting Edge Services Ltd of Matrix Park, Western Avenue, Buckshaw Village, Chorley, PR7 7NB.

A drum drive 20 is also located within the housing 2. Drum belt 22 extends between the drum drive 20 and the rotatable drum 10 so as to be able to transfer torque from the drum drive 20 to the drum 10. Thus rotation of the drum 10 may be effected.

Also disposed within the housing 2 is a knotting mechanism 24 which may selectively engage the ligature 16 and subsequently knot one portion of the ligature to another. The knotting mechanism 12 is driven by a knotting mechanism drive 26 and an associated knotting mechanism drive belt 28.

Referring to FIGS. 2 to 5, the operation of the tying machine 100 can be well appreciated.

In a first stage of the operation of the tying machine 100, a plurality of sticks 4 is placed within the aperture 6 so as to extend through a plane generally defined by the axis about which the drum 10 rotates and by a point at the shuttle 12 where the ligature can be clamped. For the convenience of the human operator the plurality of sticks 4 are rested on the work surface 11. When the sticks are placed on the work surface 11 they should be held in the desired form by, for example, the operator.

With the plurality of sticks 4 in a suitable position on the work surface 8, the drum drive 20 may be powered on so as to rotate its shaft (not shown) in a counter-clockwise direction. The rotation of the drum drive shaft (not shown) thus imparts an anticlockwise rotation to the drum 10 by means of the drum belt 22.

As can be seen from FIG. 3, as the drum 10 rotates, the shuttle 12 rotates with the drum and thereby orbits the plurality of sticks 4. As the shuttle 12 moves from its original position, as shown in FIG. 2 and FIG. 1, to the position shown in FIG. 3, the path from the ligature reservoir 14 to the shuttle 12 via the feed mechanism 18 and becomes longer. Therefore, as the shuttle 12 is rotated, additional ligature 16 must be evolved from the ligature reservoir 14 to compensate for the lengthening path. Meanwhile the tensioning spring 17 ensures that the tension in the ligature 16 between the tensioning spring 17 and the shuttle 12 is kept constant. The tensioning spring 17 helps to provide that the resilient ligature is applied in a stretched state.

After reaching the position shown in FIG. 3, the shuttle 12 continues to rotate about the propellant sticks 4 and eventually the ligature 16 abuts the sticks 4. The friction between the plurality of sticks 4 and the ligature 16 is sufficiently low that the ligature 16 may slide over the plurality of sticks 4. In the position shown in FIG. 4, the drum 10 has now completed almost three quarters of a revolution and the ligature 16 extends around approximately half of a circumference of the cross section of the bundle of sticks 4. By the time that the shuttle 12 has reached the position shown in FIG. 5, equivalent to approximately one and a quarter revolutions of the drum 10, the plurality of sticks 4 are, at a particular circumference, completely surrounded by a length of ligature 16.

Once the plurality of sticks 4 are surrounded by a length of ligature 16, the knotting mechanism 24 can engage the ligature 16 and put a knot in the ligature 16 thereby securing the ligature 16 about the plurality of sticks 4 and thus forming a bundle which may be used to make up a propellant charge. The knotting mechanism 24 secures the ligature 16 in a stretched state.

An end portion of a bundle 200 is shown in FIG. 6. As can be seen, a resilient ligature 216 has been wound around the plurality of sticks three times, that is to say the drum completed approximately three and a quarter revolutions, at approximately the same circumference prior to the securing of the ligature 216 with knot 219 and subsequently cutting the ligature 216. Further ligatures may be applied to other distinct circumferences and in fact it may be preferred to have at least two ligatures applied at distinct circumferences in order to prevent the sticks from splaying.

Solid propellant compositions, such as those which form the propellant sticks 4 are generally nitrocellulose-based and may have additives that are, like nitrocellulose, also energetic. Such additives include nitro-glycerine (in “Double Based Propellants”), nitro-guanidine (in “Triple Based Propellants”) and RDX (in “HE Propellants”). Thus the sticks 4 are prone to accidental initiation from various stimuli including electric sparks.

Therefore, it is advantageous to provide that all of the components of the tying machine 100 are suitable for use with such highly sensitive combustible materials. In particular, electrical components, such as the drum drive 20, must be manufactured to the correct specifications so that the risk of the electrical component inadvertently initiating the propellant material is minimised. The relevant design standards such as those contained in the UK ATEX Regulations should be followed where appropriate.

Various amendments will be possible to the described embodiment without departing from the scope of the invention. For example the ligature could be secured by means other than a knotting mechanism. Further, the skilled man would understand that features from a certain aspect of the invention may be equivalently combined with another aspect of the invention.

It is within the scope of the invention, and in particular the third aspect, that the ligature may be in the form of an adhesive tape. The tape may be resilient. Such a ligature, when suitably implemented in a tying machine, offers the advantage of being able to secure the ligature without the provision of a knotting mechanism, the absence of the knotting mechanism tending to reduce the weight and cost of the machine.

The work surface may have an alternative form chosen according to the propellant charge being manufactured. Where bundles for use in a 105 mm round are being used, for example, the recess could have a corresponding appropriately sized diameter.

The work surface may even be provided with modular inserts for fixing to the housing to meet the specifications, for example dimensions, of the bundle being formed.

The work surface may also be provided with weighing scales so that the weight of the bundle of sticks can be confirmed as being consistent from bundle to bundle. Preferably such scales would be integrated into the machine such that the sticks may be weighed as they rest in the recess.

Further modifications and adaptations will be obvious to the skilled man and in particular, it would be understood how features from one aspect of the invention could be included within another aspect of the invention.

1. A tying machine suitable for binding a plurality of propellant sticks to form a bundle, the bundle being suitable for use as a propellant charge, the tying machine comprising:—
a housing defining an aperture such that the aperture may accommodate the plurality of propellant sticks;
a shuttle for engaging a portion of a ligature; and
a holder fixed to the housing, the holder being suitable for holding a reservoir of a resilient ligature, the reservoir being suitable for evolving the ligature,
wherein, if the shuttle engages a portion of the ligature, and if the plurality of propellant sticks are suitably disposed in the aperture, the shuttle can be moved relative to the plurality of propellant sticks to wind the ligature around the plurality of propellant sticks to form the bundle,
and wherein the machine is adapted for use with sensitive combustible materials.

2. A tying machine according to claim 1 further comprising a rotatable drum surrounding the aperture wherein the shuttle is fixed to the drum such that
if the shuttle engages a portion of the ligature, and if the plurality of propellant sticks are suitably disposed in the aperture, rotating the drum winds the ligature around the plurality of propellant sticks to form the bundle
and wherein the tying machine further comprises an electric drive for rotating the drum, the drive conforming to explosive electrical standards.

3. A tying machine according to claim 1 comprising a work surface upon which the plurality of propellant sticks may rest.

4. A tying machine according to claim 1 wherein the tying machine comprises:
a feed mechanism for pulling the ligature out from the reservoir evenly as the shuttle moves.

5. A tying machine according to claim 4 wherein the feed mechanism comprises:
a tensioning means, for conducting the ligature between the holder and the shuttle,
such that the portion of the ligature extending from the tensioning means to the shuttle is at a generally constant tension.

6. A tying machine according to claim 1 further comprising:
a knotting mechanism for, once the plurality of propellant sticks are surrounded by the ligature, fixing the end of the ligature to another section of the ligature,
wherein the knotting mechanism comprises a drive, the drive conforming to explosive electrical standards.

7. A tying machine according to claim 1 further comprising a reservoir of ligature.

8. A process of forming a propellant charge using a machine according to claim 1 comprising the steps of:
i) arranging a plurality of sticks of propellant material into a bundle form,
ii) placing the plurality of sticks within the aperture,
iii) rotating a shuttle relative to the plurality of sticks for at least one complete revolution, the shuttle being fixed to a portion of a resilient ligature so that the ligature is wound around the bundle form, and
iv) securing the ligature to bind the sticks.

9. A propellant charge formed by the process of claim 8, comprising:
a plurality of sticks formed from propellant material, the sticks being arranged in a bundle form;
a resilient ligature surrounding the bundle at least one circumference,
wherein the resilient ligature is secured such that it holds the sticks of propellant material in the bundle form.

10. A propellant charge according to claim 9 wherein the resilient ligature comprises resilient polymeric material.

11. A propellant charge according to claim 9 wherein the resilient ligature comprises of a combination of polyamide, polyester and rubber or a combination of cotton, polyester and rubber.

12. A propellant charge according to claim 9 wherein the resilient ligature comprises a protective sheath surrounding at least one resilient cord.

13. A propellant charge according to claim 12 wherein the protective sheath comprises cotton.

14. A propellant charge according to claim 12 wherein the resilient cord comprises a combination of polyester and rubber.

15. A propellant charge according to claim 9 wherein the resilient ligature can remain resilient to a length that is between 120% and 250% of the original length of the resilient ligature.
